(19) United States
(12) Patent Application Publication
(10) Pub. No.: US 2025/0249750 A1
(43) Pub. Date: Aug. 7, 2025

(54) VEHICLE FUEL CELL ASSEMBLY COMPRISING AN INTEGRATED HIGH VOLTAGE JUNCTION BOX

(71) Applicant: VOLVO TRUCK CORPORATION, Göteborg (SE)

(72) Inventors: Pranav ARYA, Göteborg (SE); Adnan HRUSTIC, Göteborg (SE); Lars Rickard GROSSMANN-MADSEN, Floda (SE); Felipe MERSS, Göteborg (SE)

(73) Assignee: VOLVO TRUCK CORPORATION, Göteborg (SE)

(21) Appl. No.: 19/042,750

(22) Filed: Jan. 31, 2025

(30) Foreign Application Priority Data
Feb. 1, 2024 (SE) 2450105-8
Sep. 16, 2024 (SE) 2450912-7

(51) Int. Cl. B60L 1/00; B60K 1/04; B60L 50/71; H02M 3/00

(52) U.S. Cl. CPC B60L 1/003; B60L 50/71; H02M 3/003; B60K 1/04; B60K 2001/0422; B60L 2210/10

(57) ABSTRACT

A vehicle fuel cell assembly for a vehicle has a fuel cell stack, a high voltage junction box that comprises connection interfaces for electrical connection to a high voltage vehicle interface, the fuel cell stack and a plurality of high voltage consumers of the vehicle. The high voltage junction box is arranged adjacent the fuel cell stack.

### TECHNICAL FIELD

The disclosure relates generally to fuel cell vehicles. In particular aspects, the disclosure relates to a vehicle fuel cell assembly comprising an integrated high voltage junction box. The disclosure can be applied to heavy-duty vehicles, such as trucks, buses, and construction equipment, among other vehicle types.

### BACKGROUND

Vehicle fuel cell are provided with a fuel, such as hydrogen, and air to provide electrical energy. A vehicle fuel cell comprises not only a fuel cell stack, where chemical energy is converted to electrical energy, but also a number of components for cooling the stack, and for distributing the fuel and the air. Such components typically require electrical energy. In addition, electrical energy is to be provided from the vehicle fuel cell to a vehicle battery and typically to auxiliary consumers of the vehicle. Prior art solutions for providing or routing electrical energy within, as well as to and from, vehicle fuel cells are marred with various drawbacks such as complex, bulky and expensive design and time-consuming assembly.

### SUMMARY

According to a first aspect of the disclosure, there is provided a vehicle fuel cell assembly for a vehicle. The vehicle fuel cell assembly comprises a fuel cell stack and a high voltage junction box that comprises connection interfaces for electrical connection to a high voltage vehicle interface, the fuel cell stack, and a plurality of high voltage consumers of the vehicle. The high voltage junction box is arranged adjacent the fuel cell stack. The first aspect of the disclosure may seek to solve or mitigate the problems of the prior art solutions. In particular, the present vehicle fuel cell assembly may reduce the number of components, provide for a compact design and allow for quick assembly and installation. The routing of electrical conductors may be simplified and require less, e.g. shorter, conductors. Some prior art solutions may be based on providing a number of separate junction boxes, where the present solution may be based on fewer, typically one single high voltage junction box, that may be integrated in the vehicle fuel cell assembly together with the fuel cell stack.

Optionally in some examples, including in at least one preferred example, the high voltage vehicle interface is a high voltage battery.

Optionally in some examples, including in at least one preferred example, the high voltage vehicle interface is an additional high voltage junction box.

Optionally in some examples, including in at least one preferred example, the high voltage junction box comprises a converter for conversion of a voltage of the fuel cell stack. Thereby, the may be no need for providing a separate converter for converting the voltage of the fuel cell stack. In addition, the electrical connection between the converter and the fuel cell stack may be simplified and cost-effective.

Optionally in some examples, including in at least one preferred example, the converter may be adapted for conversion of a voltage of the fuel cell stack to a voltage of the connection interface for electrical connection to the high voltage vehicle interface. Thus, the converter may be operatively arranged between the fuel cell stack such that electric power generated in the fuel cell stack may be provided to the high voltage vehicle interface. No further components may be required operatively between the fuel cell stack and the high voltage vehicle interface.

Optionally in some examples, including in at least one preferred example, the high voltage junction box comprises one single converter for conversion of a voltage of the fuel cell stack to a voltage of the connection interface for connection to the high voltage vehicle interface. Such as solution may be compact and cost-effective.

Optionally in some examples, including in at least one preferred example, the connection interface for electrical connection to the high voltage vehicle interface is a DC connection interface. Thereby, said connection interface may connect directly to the high voltage vehicle interface.

Optionally in some examples, including in at least one preferred example, the current transfer capability of the connection interface for electrical connection to the high voltage vehicle interface is at least 250 amperes. Such transfer capability may render the vehicle fuel cell assembly suitable for power-demanding vehicles, such as heavy-duty vehicles. The current transfer capability of the connection interface for electrical connection to the high voltage vehicle interface may be at least 500 amperes.

Optionally in some examples, including in at least one preferred example, the connection interface for electrical connection to the high voltage vehicle battery is adapted for cables having a conductor area of at least 100 mm². Such conductor area may render the vehicle fuel cell assembly suitable for power-demanding vehicles, such as heavy-duty vehicles.

Optionally in some examples, including in at least one preferred example, at least one of the connection interfaces is adapted for cable lugs. Such a solution may allow for quick installation, i.e. connection of conductors to the high voltage junction box. In some detail, a conductor such as a cable may comprise a cable lug, and the cable lug may passed over a protruding connector of the connection interface and secured by a threaded member.

Optionally in some examples, including in at least one preferred example, at least one of the connection interfaces are adapted for cable plugs. Such a solution may allow for a particularly quick installation, i.e. connection of conductors to the high voltage junction box. In some detail, a conductor such as a cable may comprise a cable plug, and the cable plug may inserted into a socket of the connection interface.

Optionally in some examples, including in at least one preferred example, the vehicle fuel cell assembly comprises at least one fuse associated with at least one connection interface, said fuse being positioned inside the high voltage junction box. Thereby, there may be less or no need for fuses outside the high voltage junction box. In addition, the fuses may be readily available for inspection, replacement or service inside the high voltage junction box.

Optionally in some examples, including in at least one preferred example, the vehicle fuel cell assembly comprises at least one fuse associated with at least one connection interface, said fuse being positioned outside the high voltage junction box.

Optionally, in some examples, including in at least one preferred example, the high voltage consumers of the vehicle comprises a fan, a coolant pump, a compressor, or an electrical turbo charger.

Optionally in some examples, including in at least one preferred example, the high voltage junction box comprises a connection interface for electrical connection to auxiliary consumers. Thereby, there may be no need for any additional junction boxes for providing electrical power to auxiliary consumers.

Optionally in some examples, including in at least one preferred example, the auxiliary consumers comprise an electric power take-off or a brake resistor.

Optionally in some examples, including in at least one preferred example, the high voltage vehicle interface is located outside the high voltage junction box. Thereby, the high voltage junction box may be relatively compact and arranged adjacent, for examples attached to, the fuel cell stack. Further, such a high voltage junction box may be used together with voltage vehicle batteries of various sizes.

Optionally in some examples, including in at least one preferred example, the high voltage junction box is arranged immediately adjacent the fuel cell stack. Conductors connecting the high voltage junction box to the fuel cell stack may thereby be particularly short. Typically, the high voltage junction box may be arranged immediately next to, or placed on top of the fuel cell stack. Typically, a high voltage junction box arranged next to or on top of the fuel cell stack is readily available for inspection and service. The high voltage junction box may rest on the fuel cell stack.

Optionally in some examples, including in at least one preferred example, the high voltage junction box is attached to the fuel cell stack. The high voltage junction box may be mounted on the fuel cell stack. The high voltage junction box may be mounted on top of the fuel cell stack.

Optionally in some examples, including in at least one preferred example, the high voltage junction box comprises a side with a box conductor opening that is arranged immediately adjacent the fuel cell stack, such that a conductor may extend through the box conductor opening and directly into the fuel cell stack. Thereby, a particularly short connector between the high voltage junction box and the fuel cell stack may be used.

Optionally in some examples, including in at least one preferred example, the high voltage junction box comprises a controller for controlling the vehicle fuel cell assembly. For examples, the controller may be configured to control components such as a fan, a coolant pump, a compressor, or an electrical turbo charger. In addition, or alternatively, the controller may be configured to control valves regulating a flow of air or fuel to and from the fuel cell stack.

Optionally in some examples, including in at least one preferred example, the high voltage vehicle interface is a high voltage vehicle battery.

Optionally in some examples, including in at least one preferred example, the high voltage vehicle interface is an additional high voltage junction box.

According to a second aspect of the disclosure, there is provided a vehicle comprising the vehicle fuel cell assembly of the first aspect. The vehicle may be a heavy-duty vehicle.

Optionally in some examples, including in at least one preferred example, the heavy-duty vehicle comprises a driver compartment, or cab, and the vehicle fuel cell assembly is positioned below the driver compartment, i.e. at the front of the heavy-duty vehicle. The vehicle fuel cell assembly may be positioned in the so called module under cab, MUC.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1A is a schematic illustration of a vehicle fuel cell assembly and a vehicle in which the vehicle fuel cell assembly is arranged, according to an example.

FIG. 1B is a schematic illustration of a vehicle fuel cell assembly and a vehicle in which the vehicle fuel cell assembly is arranged, according to an example.

FIG. 2 illustrates an example of the vehicle fuel cell assembly of FIG. 1 in more detail.

FIG. 3 shown an example of a heavy-duty vehicle comprising the vehicle fuel cell assembly of FIG. 1 or FIG. 2.

### DETAILED DESCRIPTION

The detailed description set forth below provides information and examples of the disclosed technology with sufficient detail to enable those skilled in the art to practice the disclosure.

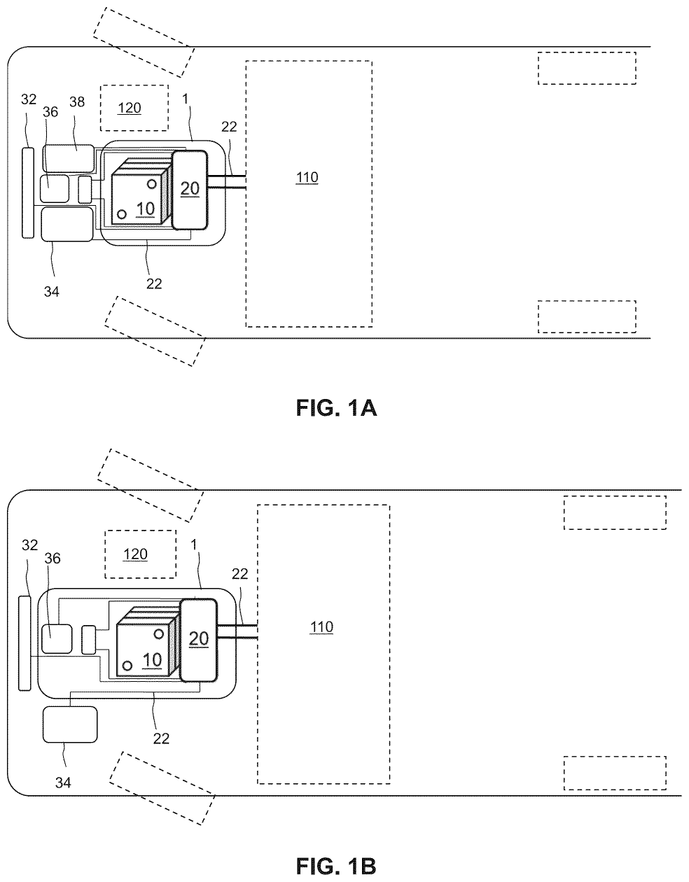

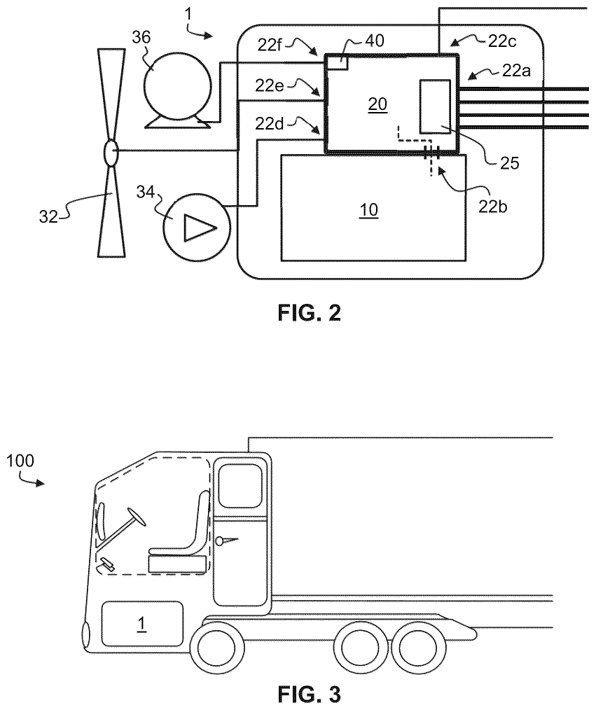

FIG. 1 schematically illustrates a plan view from above of a vehicle fuel cell assembly 1 arranged in a vehicle 100 according to two examples (FIG. 1A and FIG. 1B). FIG. 2 is a more detailed side view illustration of vehicle fuel cell assembly 1 in a similar configuration.

Referring to FIG. 1 and FIG. 2 there is disclosed a vehicle fuel cell assembly 1 for a vehicle 100. The vehicle fuel cell assembly 1 comprises a fuel cell stack 10 and a high voltage junction box 20. The high voltage junction box 20 comprises connection interfaces 22 for electrical connection to a high voltage vehicle interface 110, and to the fuel cell stack 10. The high voltage junction box 20 is arranged adjacent the fuel cell stack 10.

In one example, the high voltage vehicle interface 110 is a high voltage vehicle battery. In one example, the high voltage vehicle interface 110 is an additional high voltage junction box. In the following example, the high voltage vehicle interface 110 is referred to as a high voltage vehicle battery.

In one example, the connection interfaces 22 are configured for electrical connection to a plurality of high voltage consumers 32, 34, 36, 38 of the vehicle 100. The connection interfaces 22 may comprise at least one connector for electrical connection to at least one high voltage consumer of the vehicle 100.

The present high voltage junction box 20 further comprises a converter 25 for conversion of a voltage of the fuel cell stack 10, as illustrated in FIG. 2. The present converter 25 is adapted for conversion of a voltage of the fuel cell stack 10 to a voltage of the connection interface 22a (FIG. 2) for electrical connection to the high voltage vehicle battery 110. In the present examples, the high voltage junction box 20 comprises one single such converter 25.

The connection interface 22a for electrical connection to the high voltage vehicle battery 110 may advantageously be a DC connection interface. This may be advantageous as an AC connection interface would require external rectifies for connection to a battery. The current transfer capability of the connection interface 22a for electrical connection to the high voltage vehicle battery 110 may be at least 250 amperes, or at least 500 amperes. Said connection interface 22a may be adapted for cables having a conductor area of at least 100 mm². The connection interface 22a for electrical connection to the high voltage vehicle battery 110 may be referred to as a battery connection interface 22a.

At least one of the connection interfaces 22 of the present high voltage junction box 20 may be adapted for cable lugs or cable plugs.

As is illustrated in FIG. 2, the vehicle fuel cell assembly 1 may comprise at least one fuse 40 associated with at least one connection interface 22. The fuse 40 may be positioned inside the high voltage junction box 20, see FIG. 2. In alternative or addition, there may be at least one fuse (not shown) associated with at least one connection interface, said fuse being positioned outside the high voltage junction box 20.

Referring again to FIGS. 1A and 1B, the high voltage consumers of the vehicle 100 may comprise a fan 32, a coolant pump 34 and/or a compressor 36. In one example, the compressor is part of the vehicle fuel cell assembly 1 (as shown in FIG. 1B). The compressor may be a fuel compressor.

FIG. 1 indicates that there may be further high voltage consumers, such as an electrical turbo charger 38.

In one example, the high voltage junction box 20 may thus comprise a battery connection interface 22a for electrical connection to the high voltage vehicle battery 110, a stack connection interface 22b for electrical connection to the fuel cell stack 10, a pump connection interface 22d for electrical connection to the coolant pump 34, a fan connection interface 22e for electrical connection to the fan 32, and/or a compressor connection interface 22f for electrical connection to the compressor 36. Further, high voltage junction box 20 may for example comprise an undepicted turbo connection interface for electrical connection to an electrical turbo charger.

As in shown in FIG. 2, the high voltage junction box 20 may comprise a connection interface 22c for electrical connection to auxiliary consumers 120. An example of an auxiliary consumer 120 is an electric power take-off 120 as illustrated in FIG. 1, or an undepicted brake resistor. The connection interface for electrical connection to the auxiliary consumers 120 may be referred to as an auxiliary connection interface 22c.

FIG. 1 schematically illustrates two cables leading from the battery connection interface 22a to the high voltage vehicle battery 110, whereas FIG. 2 shows four cables which corresponds to a typical implementation. Each one of the four cables may have a conductor area of at least 100 mm², such as 120 mm².

The connection interfaces 22a-22f may typically be adapted for different electrical loads. For example, the battery connection interface 22a may be adapted for transferring a greater electric power than the fan connection interface 22e. A connection interface 22 may for example be a socket for receiving a cable plug, a terminal through-hole to which a cable lug may be screwed, or a terminal element to which a conductor such as a cable may be welded or soldered.

As is illustrated in FIG. 1, the high voltage vehicle battery 110 may be located outside the high voltage junction box 20. The vehicle 100 may comprise undepicted fuel tanks, containing for example hydrogen, and an undepicted propulsion motor.

As is also illustrated, the high voltage junction box 20 may be arranged immediately adjacent the fuel cell stack 10. Typically, the present high voltage junction box 20 is attached to the fuel cell stack 10. In the example of FIG. 1, the high voltage junction box 20 is attached to a side of the fuel cell stack 10. In the example of FIG. 2, the high voltage junction box 20 is attached to a top of the fuel cell stack 10.

Referring again to FIG. 2, the high voltage junction box 20 may comprise a side (bottom side in FIG. 2) that is arranged immediately adjacent the fuel cell stack 10. Said side may comprise a box conductor opening as is indicated in FIG. 2. A conductor, illustrated by a dashed line, may extend through the box conductor opening and directly into the fuel cell stack 10. The box conductor opening may thus be arranged immediately adjacent the fuel cell stack 10, and may be aligned with a suitable location on the fuel cell stack 10 for a connection or receipt of the conductor.

The high voltage junction box 20 may comprise an undepicted controller for controlling the vehicle fuel cell assembly 1. The controller may e.g. control the fan 32 and the coolant pump 34.

FIG. 3 shows a vehicle 100 that comprises the vehicle fuel cell assembly 1. In the present example, the vehicle is a heavy-duty vehicle. The heavy-duty vehicle comprises a driver compartment, or cab. The vehicle fuel cell assembly 1 is positioned below the driver compartment, i.e. at the front of the heavy-duty vehicle.

A vehicle fuel cell assembly or a fuel cell typically comprises fuel cell stacks 10, schematically illustrated in to FIG. 1 and FIG. 2. These stacks typically comprise bipolar plates, electrical connections, as well as inputs and outputs for cathode gas (typically air) and anode gas (such as hydrogen). The features and functions of fuel cells, including fuel cell stacks, are known to persons skilled in the art and not described in detail herein.

Also disclosed are examples according to the following examples:
1. A vehicle fuel cell assembly (1) for a vehicle (100), the vehicle fuel cell assembly (1) comprising: a fuel cell stack (10); a high voltage junction box (20) that comprises connection interfaces (22) for electrical connection to: a high voltage vehicle interface (110); the fuel cell stack (10) and a plurality of high voltage consumers (32, 34, 36) of the vehicle (100); wherein the high voltage junction box (20) is arranged adjacent the fuel cell stack (10).
2. The vehicle fuel cell assembly (1) of example 1, wherein the high voltage junction box (20) comprises a converter (25) for conversion of a voltage of the fuel cell stack (10).
3. The vehicle fuel cell assembly (1) of example 2, wherein the converter (25) is adapted for conversion of a voltage of the fuel cell stack (10) to a voltage of the connection interface (22a) for electrical connection to the high voltage vehicle interface (110).
4. The vehicle fuel cell assembly (1) of example 3, wherein the high voltage junction box (20) comprises one single converter (25) for conversion of a voltage of the fuel cell stack (10) to a voltage of the connection interface (22a) for connection to the high voltage vehicle interface (110).
5. The vehicle fuel cell assembly (1) of any preceding example, wherein the connection interface (22a) for electrical connection to the high voltage vehicle interface (110) is a DC connection interface.
6. The vehicle fuel cell assembly (1) of example 5, wherein the current transfer capability of the connection interface (22a) for electrical connection to the high voltage vehicle interface is at least 250 amperes.
7. The vehicle fuel cell assembly (1) of example 5 or 6, wherein the connection interface (22a) for electrical connection to the high voltage vehicle interface (110) is adapted for cables having a conductor area of at least 100 mm².
8. The vehicle fuel cell assembly (1) of any preceding example, wherein at least one of the connection interfaces (22) is adapted for cable lugs.
9. The vehicle fuel cell assembly (1) of any preceding example, wherein at least one of the connection interfaces (22) are adapted for cable plugs.
10. The vehicle fuel cell assembly (1) of any preceding example, comprising at least one fuse (40) associated with at least one connection interface (22), said fuse (40) being positioned inside the high voltage junction box (20).
11. The vehicle fuel cell assembly (1) of any preceding example, comprising at least one fuse associated with at least one connection interface, said fuse being positioned outside the high voltage junction box (20).
12. The vehicle fuel cell assembly (1) of any preceding example,
13. The vehicle fuel cell assembly (1) of any preceding example, wherein the high voltage consumers of the vehicle (100) comprise a fan (32), a coolant pump (34), a compressor (36), or an electrical turbo charger.
14. The vehicle fuel cell assembly (1) of any preceding example, wherein the high voltage junction box (20) comprises a connection interface (22c) for electrical connection to auxiliary consumers (120).
15. The vehicle fuel cell assembly (1) of example 13, wherein the auxiliary consumers comprise an electric power take-off or a brake resistor.
16. The vehicle fuel cell assembly (1) of any preceding example, wherein the high voltage vehicle interface (110) is located outside the high voltage junction box (20).
17. The vehicle fuel cell assembly (1) of any preceding example, wherein the high voltage junction box (20) is arranged immediately adjacent the fuel cell stack (10).
18. The vehicle fuel cell assembly (1) of any preceding example, wherein the high voltage junction box (20) is attached to the fuel cell stack (10).
19. The vehicle fuel cell assembly (1) of any preceding example, wherein the high voltage junction box (20) comprises a controller for controlling the vehicle fuel cell assembly (1).
20. A vehicle (100) comprising the vehicle fuel cell assembly (1) of any preceding examples.
21. The vehicle (100) of example 19, wherein the vehicle is a heavy-duty vehicle.
22. The heavy-duty vehicle (100) of example 20, wherein the heavy-duty vehicle comprises a driver compartment, or cab, and the vehicle fuel cell assembly (1) is positioned below the driver compartment, i.e. at the front of the heavy-duty vehicle.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A vehicle fuel cell assembly for a vehicle, the vehicle fuel cell assembly comprising
a fuel cell stack
a high voltage junction box that comprises connection interfaces for electrical connection to
a high voltage vehicle interface,
the fuel cell stack, and
a plurality of high voltage consumers of the vehicle,
wherein the high voltage junction box is arranged adjacent the fuel cell stack.

2. The vehicle fuel cell assembly of claim 1, wherein the high voltage junction box comprises a converter for conversion of a voltage of the fuel cell stack.

3. The vehicle fuel cell assembly of claim 2, wherein the converter is adapted for conversion of a voltage of the fuel cell stack to a voltage of the connection interface for electrical connection to the high voltage vehicle interface.

4. The vehicle fuel cell assembly of claim 3, wherein the high voltage junction box comprises one single converter for conversion of a voltage of the fuel cell stack to a voltage of the connection interface for connection to the high voltage vehicle interface.

5. The vehicle fuel cell assembly of claim 1, wherein the connection interface for electrical connection to the high voltage vehicle interface is a DC connection interface.

6. The vehicle fuel cell assembly of claim 5, wherein the current transfer capability of the connection interface for electrical connection to the high voltage vehicle interface is at least 250 amperes.

7. The vehicle fuel cell assembly of claim 5, wherein the connection interface for electrical connection to the high voltage vehicle interface is adapted for cables having a conductor area of at least 100 mm².

8. The vehicle fuel cell assembly of claim 1, comprising at least one fuse associated with at least one connection interface, said fuse being positioned inside the high voltage junction box.

9. The vehicle fuel cell assembly of claim 1, wherein the high voltage vehicle interface is a high voltage vehicle interface.

10. The vehicle fuel cell assembly of claim 1, wherein the high voltage consumers of the vehicle comprises comprise a fan, a coolant pump or a compressor.

11. The vehicle fuel cell assembly of claim 1, wherein the high voltage junction box comprises a connection interface for electrical connection to auxiliary consumers.

12. The vehicle fuel cell assembly of claim 1, wherein the high voltage vehicle interface is located outside the high voltage junction box.

13. The vehicle fuel cell assembly of claim 1, wherein the high voltage junction box is arranged immediately adjacent the fuel cell stack.

14. A vehicle comprising the vehicle fuel cell assembly of claim 1.

15. The vehicle of claim 14, being a heavy-duty vehicle comprising a driver compartment, or cab, wherein the vehicle fuel cell assembly is positioned below the driver compartment.
